(19) United States
(12) Patent Application Publication
(10) Pub. No.: US 2020/0378251 A1
(43) Pub. Date: Dec. 3, 2020

(54) LIQUID SAMPLING DEVICE AND ASSOCIATED METHODS

(71) Applicant: WATERRA PUMPS LIMITED, Mississauga (CA)

(72) Inventors: John H. MCADAM, Calgary (CA); John NEWALL, Mississauga (CA); William Ronald SOMERVILLE, Ajax (CA); Alain POIRIER, Lac-Beauport (CA); Christian GAUVIN, Levis (CA); Jean-Sebastien LANGLOIS, Quebec (CA)

(21) Appl. No.: 16/885,259

(22) Filed: May 27, 2020

Related U.S. Application Data
(60) Provisional application No. 62/853,578, filed on May 28, 2019.

(51) Int. Cl. E21B 49/08; F16K 1/228; F16K 15/02

(52) U.S. Cl. CPC E21B 49/082; F16K 15/021; F16K 1/228; E21B 49/083

(57) ABSTRACT

A liquid sampler for use in sampling the liquid in a well. The sampler has a tube for containing the sample and an inlet at the bottom and an outlet at the top. An inlet check valve is located at the inlet which has a door configured autonomously to move between open and closed configurations in response to fluid flow through the inlet. In the open configuration, the door is aligned with the axis of the tube to allow fluid to flow into the tube through the inlet from below, and in the closed configuration, the door is positioned transverse to the axis of the tube to block fluid flow from the tube out through the inlet thereby retaining fluid within the tube as the sampler is raised up.

### CROSS REFERENCE TO RELATED APPLICATIONS

The present application claims priority to U.S. Provisional Application No. 62/853,578, filed on May 28, 2019. The entire contents of the above-listed application are hereby incorporated by reference for all purposes.

### FIELD OF THE INVENTION

The invention relates to liquid sampling devices and associated methods. In particular, the invention relates to water sampling devices for use in groundwater monitoring wells.

### BACKGROUND

The purpose of groundwater sampling is to collect samples representative of the groundwater at the sampling point. These samples are then analysed to determine, for example, the presence of contaminates or other compounds.

SESD Operating Procedure SESDPROC-301-R3 (Effective Date: Mar. 6, 2013) provides general and specific procedures, methods and considerations to be used and observed when collecting groundwater samples for field screening or laboratory analysis.

In order to obtain a sample representative of the fresh formation water derived directly from the aquifer rather than just from the well which could, for example, include stagnant water, the well may be purged prior to sampling. Purging is the process of removing stagnant water from a well, immediately prior to sampling, causing its replacement by groundwater from the adjacent formation that is representative of actual aquifer conditions. In order to determine when a well has been adequately purged, field investigators should generally monitor, at a minimum, the pH, specific conductance and turbidity of the groundwater removed during purging and, in the case of permanent monitoring wells, observe and record the volume of water removed.

Sampling is the process of obtaining, containerizing, and preserving (if required) a ground water sample (e.g. after the purging process is complete). Non-dedicated pumps for sample collection generally are not typically used. Many pumps are made of materials such as brass, plastic, rubber, or other elastomeric products which may cause chemical interferences with the sample. Their principle of operation may also render them unacceptable as a sample collection device.

A sample may be obtained using a bailer. The bailer should be gently immersed in the top of the water column until just filled. At this point, the bailer is then slowly removed, and the contents emptied into the appropriate sample containers.

Other sampling options include using HydraSleeve™ or Passive diffusion bag (PDB) sampling.

The HydraSleeve™ system is described in US 2016/123,142 which relates to a sampler for collecting fluid samples includes a flexible tube having a sealed first end and a second end, the tube defining an interior cavity, a check valve disposed at the second end of the tube, and at least one aperture above the check valve. To collect fluid samples, the sampler is lowered into the fluid to be sampled. Once the sampler reaches the desired depth, the sampler is pulled upwards allowing fluid to enter the interior cavity. The sampler is then pulled out of the fluid without losing any of the fluid in the interior cavity of the tube or contaminating the sample with any extraneous fluid.

Passive diffusion bag samplers are used to collect water samples from groundwater aquifers for analysis of specific chemical compounds. The samplers are generally hung from a cable and placed in monitoring wells at the well screen for periods of at least 14 days, or until equilibrium has taken place between the water in the sampler and surrounding groundwater. They operate by diffusion of contaminants across a polyethylene membrane. Generally, no purging or disposal of purge water is necessary for passive diffusion bag samplers.

Passive diffusion bag samplers may be made of low-density polyethylene (LDPE), which acts as a semi-permeable membrane. Volatile Organic Compounds (VOCs), excluding certain ketones, ethers and alcohols, diffuse readily through the membrane. An equilibrium is established between the VOCs in the bag and those in the groundwater. The passive diffusion bag Sampler is filled with analyte-free water and is in the shape of a long cylindrical tube. Upon retrieval, usually 14 days after deployment, bags are opened to fill vials and returned to the laboratory for analysis.

The HYDRO-BIOS™ Free Flow Water Sampler consists of a tube with two lids connected by a latex rubber tubing/stainless steel spring. The lids are kept open during descent to enable flushing of the sampling tube. When used with a hydrographic wire, a messenger, dropped down the wire from the surface, releases the end stoppers for closure. The sampler can then be retrieved, and the water sample discharged at the surface via the discharge cock/tube at the lower end of the sampler.

### SUMMARY

In accordance with the invention, there is provided a liquid sampler comprising:

a tube for containing the sample having an inlet at the bottom and an outlet at the top, wherein the outlet is configured to allow fluid to exit the tube;
an inlet check valve at the inlet having a door configured autonomously to move between open and closed configurations in response to fluid flow through the inlet, wherein:
in the open configuration, the door is aligned with the axis of the tube to allow fluid to flow into the tube through the inlet from below, and
in the closed configuration, the door is positioned transverse to the axis of the tube to block fluid flow from the tube out through the inlet thereby retaining fluid within the tube as the sampler is raised up.

In the context of this disclosure, orientation words such as top, bottom, up and down should be construed in relation to the orientation of the sampler when it is being used to retrieve a liquid sample.

It will be appreciated that when the door is aligned with the axis of the tube, it may be oriented so as to present a minimal cross-sectional area to the water flow.

The door may be configured to rotate and/or pivot between the open and closed configurations. The door may be configured to rotate and/or pivot about an axis which is transverse to the elongate tube axis.

The door may be pivotally attached adjacent to the inlet of the tube.

The door may comprise two flaps hinged at the middle. The door may comprise a plurality of flaps hinged along a diameter of the tube. The flaps may be semicircular. Each of flaps may have the shape of half an ellipse (e.g. on one side of the minor axis). Using a half-ellipse shape may allow the edge of the flap impinge on the inner surface of a circularly cylindrical tube to form a seal in the closed configuration.

In the closed position, the angle that the flaps make with the tube axis (θ) is less than 90°. In the open position, the angle that the flaps make with the tube axis is greater than 0°. Angles of θ between 0° and 90° may be considered to correspond to the flaps pointing generally upwards towards the top of the sampler. Angles of θ between 90° and 180° may be considered to correspond to the flaps pointing generally downwards towards the bottom of the sampler.

The door may be pivotally attached to an inside surface of the tube, and wherein the door is configured to lie along the inside surface of the tube when in the open configuration.

The door may be configured to float freely within the tube between two stops located adjacent to the tube inlet.

The tube may have a circular cross-section. This may reduce mixing if the sampler rotates about its axis as it is lowered through the liquid.

The door may be configured, in the closed configuration, to be substantially the same width as the inner dimension of the tube. The door may span more than 90% (or more than 80%) of the inner dimension of the tube.

The door may be rigid. The door may be deformable.

Therefore, the ratio between the effective cross-sectional area of the sampler in the open position compared to the closed position may be less than 60% (e.g. less than 50% or less than 35%). A ratio of less than 50% may help ensure that at least as much liquid is flowing through the sampler as is being deflected by the sampler. The effective cross-sectional area of the sampler may be considered to be a projection of the solid elements of sampler onto a surface normal (e.g. perpendicular to) the elongate axis of the sampler. That is, the effective cross-sectional area is a measure of how much the liquid would be deflected as the sampler is lowered through the liquid along the elongate axis of the sampler.

The ratio between the effective cross-sectional area of the sampler in the open position compared to the closed position may be less than 20% (15%). This may be particularly the case for samplers which use valves which close with the door at an angle to the sampler axis. These samplers may close by the door impinging on the tube wall (e.g. rather than resting on a lip or stop which prevents the door passing beyond the closed position).

The door may be curved so as to lie along a curved inner surface of the tube when the door in the open configuration.

The door may be configured to pivot about a hinge axis which lies adjacent to and parallel to an inside surface of the tube.

The door may be configured to pivot about a hinge axis which lies transverse to and through an inside surface of the tube (e.g. where the door is formed from two flaps hinged in the middle).

The sampler may comprise an outlet check valve at the outlet having a door configured to move between open and closed configurations.

The sampler may be formed from plastic (e.g. clear, transparent and/or translucent plastic). The tube may be formed from plastic (e.g. clear, transparent and/or translucent plastic). The sampler may have a density greater than 1 g/cm³. The sampler may have a density greater than water to enable it to sink.

The sampler may comprise a line for lowering and raising the sampler.

According to a further aspect, there is provided a method of sampling fluid in a well using a liquid sampler comprising:

a tube for containing the sample having an inlet at the bottom and an outlet at the top, wherein the outlet is configured to allow fluid to exit the tube;
an inlet check valve at the inlet having a door configured autonomously to move between open and closed configurations in response to fluid flow through the inlet,
wherein the method comprises:
lowering the sampler into the fluid, wherein the as the liquid sampler enters and travels down through the fluid, the fluid flow causes the door to move to an open configuration in which the door is aligned with the axis of the tube to allow fluid to flow into the tube through the inlet from below to capture a sample, and
after the sample has been captured, raising the sampler up through fluid wherein when the sampler is raised, the door is configured to move to a closed configuration in which the door is positioned transverse to the axis of the tube to block fluid flow from the tube out through the inlet thereby retaining fluid within the tube as the sampler is raised up.

The line may comprise a coated stainless-steel wire (e.g. coated with Teflon® or other impermeable material). The coating may prevent the line contaminating the water. The line may also be a polyester, nylon, kevlar or polyethylene cord. At least the portion of the line which will be in contact with the water may be coated.

The tube may be rigid. The tube may be flexible.

The door may be flat. The door may be curved. the door or part of the door may be flexible.

The door may comprise a thin layer of material. The door may have a thickness of less than 1 cm (or less than 0.5 cm or less than 0.1 cm).

The density of the door may be close to that of water (e.g. within 10%). The density of the door may be greater than that of water. This may help the door to open more easily as it is lowered into the water. It may also prevent the valve closing during lowering (e.g. if the lowering rate is too slow for the flow rate to keep the valve open).

When the door is in the open configuration, the body of the door may be aligned (e.g. parallel or close to parallel) to the axis of the sampler in line with the edge of the door (i.e. to present a small effective cross-sectional area to water flow along the sampler axis). When the door is in the closed configuration, the body of the door may be aligned transverse to the axis of the sampler. In this way, the cross-sectional area of the door transverse to the fluid flow direction is larger in the closed configuration than the open configuration.

According to a further aspect, there is provided a liquid sampler comprising:

a tube for containing the sample having an inlet at the bottom, an outlet at the top, and a drain hole located near the bottom of the sampler, configured to be closed by a resilient plug;
an inlet check valve at the inlet having a door configured to move between open and closed configurations, wherein:
in the open configuration, the door is configured to allow fluid to flow into the tube through the inlet from below, and
in the closed configuration, the door is configured to retain fluid within the tube as the sampler is raised up.

The resilient plug may comprise two lobes and a waist portion, the waist portion being configured to align with the tube wall when engaged to seal the drain hole. The plug may be made from LDPE. Another piece of small diameter tubing may act as a spigot that may be used to push the plug into the sampler and fill the drain hole. The spigot may comprise a length of polyethylene tubing attached to it that can be kinked and unkinked or alternatively, have a valve to regulate the flow from the drain.

When a fluid is flowing through a closed channel such as a pipe or between two flat plates, either of two types of flow may occur depending on the velocity and viscosity of the fluid: laminar flow or turbulent flow.

In fluid dynamics, laminar flow (or streamline flow) occurs when a fluid flows in parallel layers, with no disruption between the layers. There are few cross-currents perpendicular to the direction of flow, nor eddies or swirls of fluids.

Turbulent flow is a less orderly flow regime that is characterised by eddies or small packets of fluid particles, which result in mixing.

The present technology is configured to enable laminar flow or at least minimize flow turbulence through the sampler when the valves are in the open configuration.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a is a cross-section view of a water well and an embodiment of the sampler as it is being lowered into the water.

FIG. 1b is a cross-section view of a water well and the embodiment of FIG. 1a as it is being raised out of the well.

FIG. 2a is a perspective view of an embodiment of the sampler.

FIG. 2b is an exploded perspective view of the embodiment of FIG. 2a.

FIG. 2c is a side contracted view of the embodiment of FIG. 2a.

FIG. 2d is a perspective view of one of the valves of the embodiment of FIG. 2a in an open configuration.

FIG. 2e is a cross-section side view of one of the valves of the embodiment of FIG. 2a in an open configuration

FIG. 2f is a perspective view of one of the valves of the embodiment of FIG. 2a in a closed configuration.

FIG. 2g is a side view of one of the valves of the embodiment of FIG. 2a in a closed configuration.

FIG. 2h is a top view of one of the valves of the embodiment of FIG. 2a in a closed configuration with a hanger.

FIG. 2i is a cross-section side view of the drain and plug in the tube of the embodiment of FIG. 2a.

FIG. 3a is cross-section side view of an embodiment of the sampler in a closed configuration.

FIG. 3b is cross-section side view of the embodiment of FIG. 3a in an open configuration.

FIG. 3c is cross-section end view of the embodiment of FIG. 3a in a closed configuration.

FIG. 3d is cross-section end view of the embodiment of FIG. 3a in an open configuration.

FIG. 3e is a perspective view of the valve door used in the embodiment of FIG. 3a.

FIG. 4a is a perspective cut-away view of a further embodiment of a valve in a closed position.

FIG. 4b is a further perspective cut-away view of the valve of FIG. 4a valve in a closed position.

FIG. 4c is a transverse cross-section of the valve of FIG. 4a in a closed position

FIG. 4d is a further perspective cut-away view of the valve of FIG. 4a valve in an open position.

FIG. 4e is a top view of the valve of FIG. 4a valve in an open position.

FIG. 4f is cut-away side view of the valve of FIG. 4a in an open position.

FIGS. 5-7 are cut-away side views of valves showing how the valves may be configured to seal to the tube wall.

### DETAILED DESCRIPTION

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Water Sampling

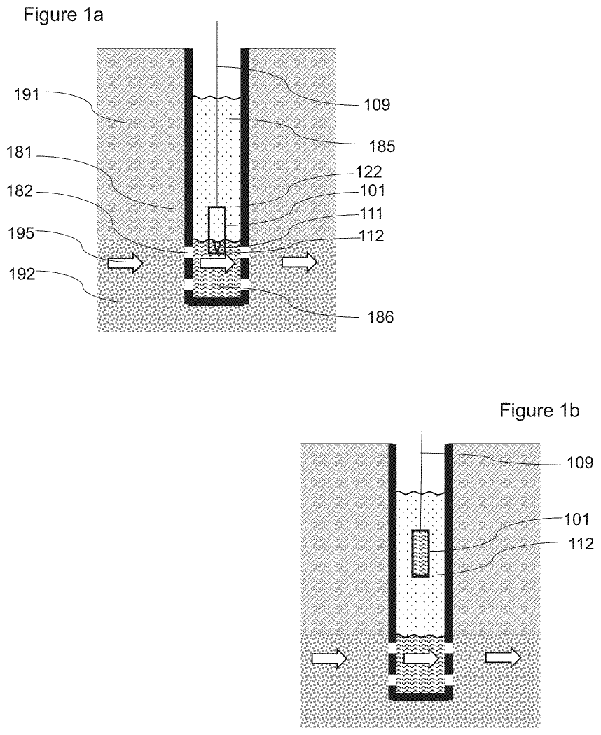

FIGS. 1a and 1b show cross-section views of a water well and an embodiment of the sampler as it is being lowered into and raised out of the water. The well has been sunk into the ground through layers of rock or surficial deposits 191 and into the aquifer 192. The well itself comprises a wall 181 of impermeable material which has a series of wellbore holes or screened interval 182 to allow water from the aquifer 192 into the wellbore.

Groundwater flow 195 within the aquifer replenishes the well when the well is emptied. When the well is left for an extended period of time, the water within the well may comprise a stagnant head 185 and a replenished volume 186 which is adjacent to the wellbore holes 182. This replenished volume 186 is replenished by the water flow in the aquifer 192 which passes through the wellbore holes 182.

When sampling the well, it is important that the water which is being sampled is from the replenished volume 186, and not the stagnant head, as it is this replenished volume which reflects the current state of the water flowing through the aquifer. The traditional method of avoiding sampling the stagnant head is to remove water from the well until no stagnant water remains. This may involve removing multiple wellbore volumes of water to ensure that the replenished water is not contaminated with previous stagnant water.

The present sampler offers an alternative approach. This involves a sampler which can travel through the stagnant head while limiting disturbance of it or mixing the stagnant head layer with the replenished volume.

FIGS. 1a and 1b show an embodiment of a liquid sampler comprising:

a tube 101 for containing the sample having an inlet 112 at the bottom and an outlet 122 at the top,
wherein the outlet 122 is configured to allow fluid to exit the tube;
an inlet check valve at the inlet having a door 111 configured autonomously to move between open and closed configurations in response to fluid flow through the inlet.

In this case, the door comprises two flaps which are hinged in the middle, along the diameter of the sampler. In FIG. 1a, the sampler is being lowered through the water on a line 109. This means that water is flowing upwards with respect to the sampler. The flow causes the two flaps to open upwards to put the inlet check valve in the open configuration. In the open configuration, the door 111 is aligned with the axis of the tube to allow fluid to flow into the tube through the inlet from below.

As shown in FIG. 1a, when the door 111 is aligned with the axis of the tube, the sampler offers a small cross-sectional area to the water flow. This means that the sampler does not disturb the water and the water can freely pass around and through the sampler. Crucially, it mitigates the effects of mixing the stagnant head with the replenished volume within the well.

After the sampler is entirely within the replenished volume, the user stops lowering the line. Then the user then starts drawing the line upwards. Initially water flows in a retrograde direction in through the outlet and out through the inlet at the bottom. This retrograde flow causes the door flaps to move downwards to close the inlet valve. In the closed configuration, the door is positioned transverse to the axis of the tube to block fluid flow from the tube out through the inlet thereby retaining fluid within the tube as the sampler is raised up through the stagnant head.

In this way, an uncontaminated sample can be obtained from the replenished volume in the well without the need for prior purging of the well. It will be appreciated that this may reduce the amount of equipment needed (such as pumps or bailers) and the amount of time (removing multiple wellbore volumes can take some time) as well as the costs of disposal of the purged water.

### Twin-Flap Double-Valve Sampler

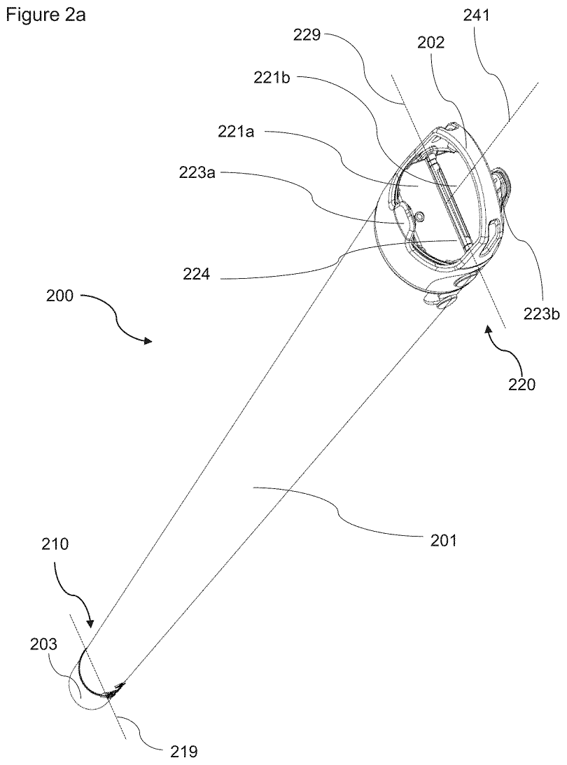

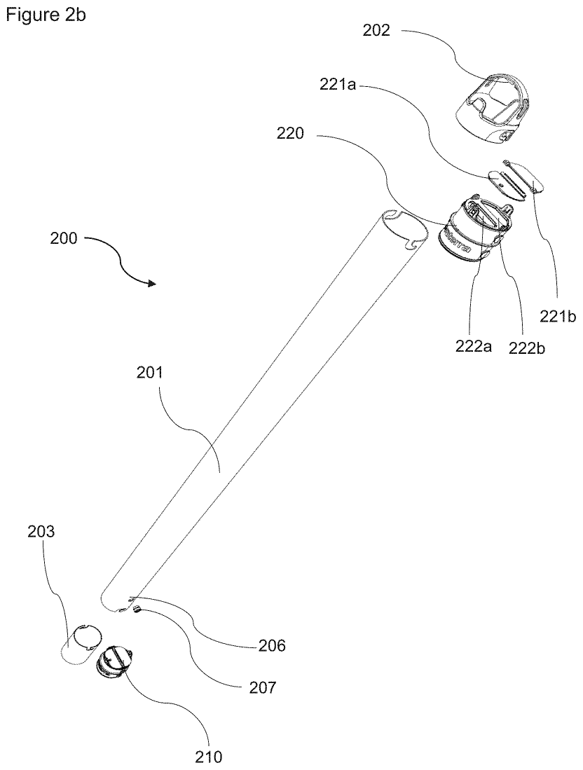

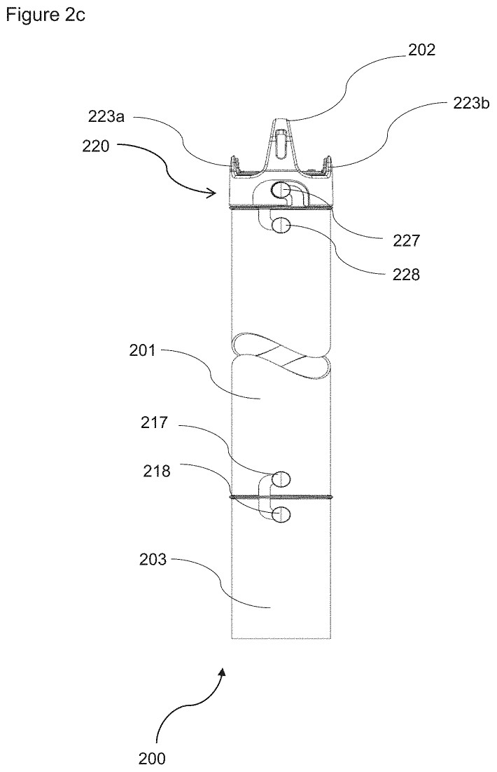

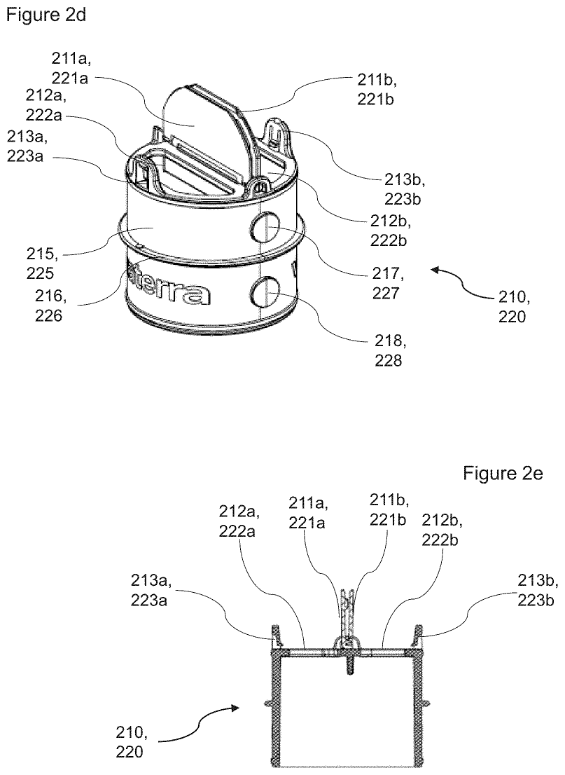

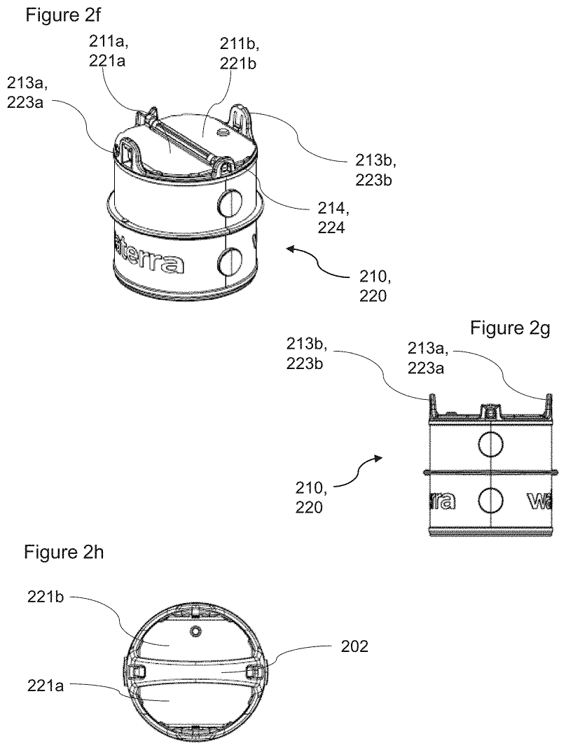

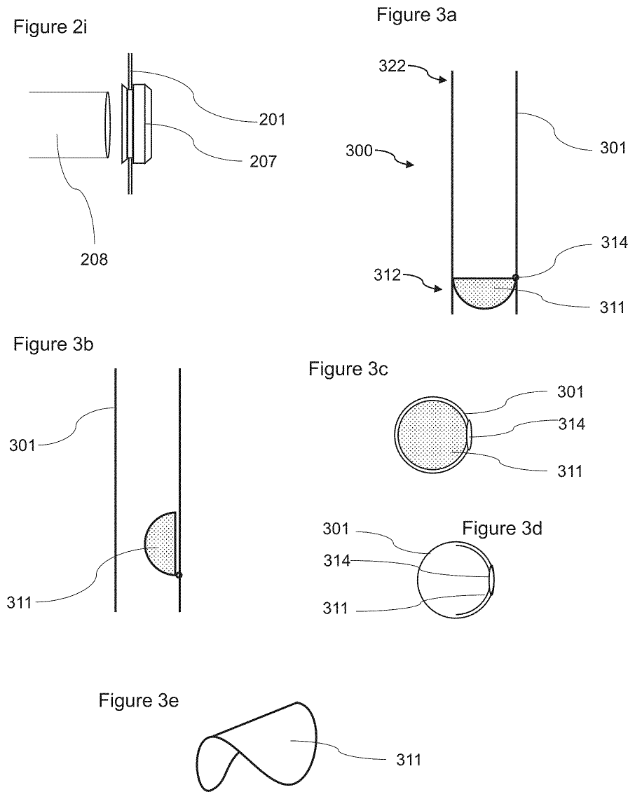

FIGS. 2a-2c show an embodiment of a twin-flap double-valve sampler. FIG. 2a is a perspective view. FIG. 2b is an exploded perspective view. FIG. 2c is a side contracted view (with the middle part of the tube omitted).

FIGS. 2d-2h are various views of the valves used in the embodiment of FIG. 2a.

The liquid sampler 200 of FIG. 2a comprises:

a tube 201 for containing the sample having an inlet 212a, 212b (see FIGS. 2d and 2e) at the bottom and an outlet 222a, 222b (see FIG. 2b) at the top, wherein the outlet 222a, 222b is configured to allow fluid to exit the tube;
an inlet check valve 210 at the inlet 212a, 212b (see FIGS. 2d and 2e) and an outlet check valve 220 at the outlet 222a, 222b (see FIG. 2b) each of the inlet and outlet valves having a door configured autonomously to move between open and closed configurations in response to fluid flow through the inlet, wherein:
in the open configuration, the door is aligned with the axis of the tube to allow fluid to flow into the tube through the inlet from below, and
in the closed configuration, the door is positioned transverse to the axis of the tube to block fluid flow from the tube out through the inlet thereby retaining fluid within the tube as the sampler is raised up.

To reduce drag and mixing, the tube 201 is configured to have a consistent cross-section along its length. That is, when the tube is travelling along its elongate axis through a liquid, once the liquid is displaced by the end of the tube, it can travel the length of the tube without impinging on further surfaces. This reduces the turbulence induced by the tube.

In this case, the door of each of the inlet and outlet valves comprises two flaps 211a, 211b, 221a, 221b hinged 214, 224 (see FIG. 20 at the middle. That is, in this case, the door comprises a plurality of flaps, each flap 211a, 211b, 221a, 221b hinged along a diameter of the tube. To move from the open to closed position, each door flap 211a, 211b, 221a, 221b is configured to rotate about a hinge axis 219, 229 which is configured to be transverse to the elongate tube axis 241.

By hinging the flap along a diameter of the tube, the distance that the flap has to move between an open and a closed configuration is reduced (e.g. compared with a flap which spans the tube and is pivoted at the edge).

In this case, the sampler is configured to be lowered by attaching a line to a handle mounted on the top of the sampler. The handle 202 diametrically spans the top of the sampler. In this case, the inlet hinge 214 (and inlet hinge axis 219), the outlet hinge 224 (and inlet hinge axis 229) and the handle 202 are configured to be lie parallel to each other. Aligning two or more of these features may help reduce induced turbulence as the sampler is lowered through the water.

In this case, the tube has a circular cross-section. This may help to reduce mixing of the water if rotation about the longitudinal sampler axis is induced as the sampler is lowered into the water (e.g. by torsion in the line).

In this case, the tube is formed from plastic. The tube, valves and hanger may be made from PVC (polyvinyl chloride). The plug and spigot may be formed from PE (polyethylene). The valve parts may be injection molded.

Regarding the inlet and outlet valves, FIGS. 2d and 2e show a valve in the open configuration, and FIGS. 2f, 2g and 2h show a valve in the closed configuration. In this embodiment, the inlet and outlet valves are identical, so numerals associated with inlet and outlet valves are shown in FIGS. 2d-2g. FIG. 2h is shown in combination with a releasably attachable handle module 202, so only numerals associated with the outlet valve are shown in this figure.

As shown in the figures, the valves 210, 220 comprise a circular body 215, 225 and a ridge 216, 226 running along a circumference of the circular body. The circular body and the ridge are configured to form a seal with the tube 201 so that, when the valves 210, 220 are closed, liquid is sealed within the sampler 200. In this case, the tube is configured to surround the body of the valves. It will be appreciated that, in other embodiments, the tube may be inserted into the inside of the valve body. Such embodiments may comprise a ridge running around the inner surface of the valve body.

In this case, the liquid sampler comprises a bottom tube extension 203 which extends below the inlet valve 210. The bottom tube extension is not configured to store the sample when the inlet and outlet valves are closed. However, the bottom tube extension may help direct flow through the sampler 200 as the sampler is being lowered through the water. In addition, if the sampler is rested on the ground at surface (or on the well bottom), the inlet valve is protected.

To connect the tube to the valve, the valve in this case comprises two sets of bayonet connectors 217, 227; 218, 228 arranged on either side of the ridge 216, 226. Using a bayonet connector allows the orientation of the valve with respect to the tube to be fixed and reproduceable. This allows the hinges of the upper and lower valves 220, 210 to be aligned.

By having two connectors, components of the sampler can be connected above and below each valve. In this embodiment, one set of connectors 217 of the inlet valve 210 are used to connect to the bottom of the tube 201; the other set of connectors 218 are used to connect to the bottom tube extension 203. Similarly, one set of connectors 227 of the outlet valve 220 are used to connect to the handle 202; the other set of connectors 228 are used for the top of the tube 201.

If the user would like to use a larger sampler, the user may build one using multiple tube and valve modules. For example, a sampler with twice the volume could be built by replacing the single tube with two tubes linked by an intermediate valve module. It will be appreciated that the door or flaps may be removed from the intermediate valve module as this module would not be acting as either the inlet our outlet in this configuration.

In this case, the door in this embodiment formed from rigid material. That is, each component is not configured to deform during operation of the sampler.

In this case, the two flaps 211a, 211b; 221a, 221b making up each valve door is configured, in the closed configuration, to be substantially the same lateral area as the inner dimension of the tube. In contrast, the two flaps 211a, 211b; 221a, 221b making up each valve door is configured, in the open configuration, to align with the tube axis. In this way, water is allowed to flow freely through and around the sampler, as the sampler is lowered.

In this case, the sampler is configured to be lowered into a wellbore comprising a pipe (e.g. a schedule (SCH) 40 2″ PVC pipe). The internal diameter of the wellbore is 2.047 in, so the cross-sectional area of wellbore is 3.29 in².

The combined area of the two door flaps 211a, 211b, 221a, 221b in one valve is 1.233 in². When open, the doors align with the central hinge and so contribute nothing to the effective cross-sectional area of the sampler when in the open position. The outer diameter of the sampler is designed as 1.75″, therefore the cross-sectional area of the sampler is 2.40 in². Therefore, the ratio between the effective cross-sectional area of the sampler in the open position compared to the closed position is (2.40−1.233) in²: 2.40 in²=49%. The smaller this ratio, the more freely may water flow through the sampler.

In this case, the annular gap area between the sampler and the wellbore (well ID−sampler OD) is 3.29 in²−2.40 in²=0.89 in². The opening in our sampler represents 58% of the open area available for water to pass (either through or around) as the sampler descends through a water column.

For comparison, a conventional disposable bailer typically has an opening of 0.61″ and an outer diameter of 1.6″. Therefore, the bailer has a cross-sectional area of 2.01 in² and an open area of 0.29 in². Therefore, the ratio between the effective cross-sectional area of the bailer in the open position compared to the closed position is at best (2.01−0.29) in²: 2.01 in²=86%.

The annular gap area for the bailer is 1.28 in². Therefore, the conventional disposable bailer represents only 19% of the open area available for water to pass (either through or around) as the bailer as it descends through a water column. Because the open area in the bailer is significantly less than the inner diameter of the bailer, water will flow much more slowly through the conventional bailer than it will through the present sampler and it may be much more turbulent.

Because the open area between the sampler and the annular gap is more balanced, the water flow through the device as it descends will be the similar to the flow around the device. This may help make the sampler suitable for zero purge sampling.

The valves each comprise locking mechanism 213a, 223a to ensure that once the door is closed, it does not open until the sampler is returned to the surface. The locking mechanism comprises a resilient locking mechanism, in this case, comprising a living hinge formed from the same material as the rest of the valve. When a force is applied to the top of a door flap, the edge of the door flap impinges on a surface of the locking member moving it out of the way. When the door flap reaches the closed configuration, it moves beyond the end of the locking member. The locking member then returns to its original position, and the end of the locking member prevents the door flap from moving upwards.

In use, the sampler would be deployed with the door flaps positioned above the locking members. This allows the door flaps to move upwards to an open configuration as the sampler is lowered down through the liquid. When the sampler reaches the desired depth, the user would stop lowering the sampler and sharply tug on the line. The downward flow of the water with respect to the sampler would cause the door flaps to move downwards with sufficient force to activate the locking mechanism locking the door flaps in the closed configuration. In this way, even if the user pauses the retrieval of the sampler as it is being raised through the stagnant head, the door flaps are prevented from reopening and contaminating the sample contained within the sampler.

In this embodiment, when the sampler has been retrieved at the surface, the sample is retrieved. In this case, the tube comprises a drain hole 206 which is sealed by a resilient plug 207 (see cross-section in FIG. 2i). When the user wishes to extract the sample, they position a drain line on the end of the plug and push. The plug 207 is deformed and pushed through the drain hole 206 into the inside of the sampler. The outer diameter of the drain line is the same as the inner diameter of the drain hole. This allows the sample to be extracted from the sampler through the drain line.

In this case, the drain line is collapsible. That is, it may be formed from a flexible or resilient material which allows the drain line to be collapsed to close the channel or alternatively, it may have a valve. This allows the flow from the sampler to be controlled.

### Single-Flap Single-Valve Sampler

FIGS. 3a-e show a further embodiment of a liquid sampler 300. In this case, the liquid sampler comprises:

a tube 301 for containing the sample having an inlet 312 at the bottom and an outlet 322 at the top, wherein the outlet is configured to allow fluid to exit the tube;
an inlet check valve at the inlet having a door configured autonomously to move between open and closed configurations in response to fluid flow through the inlet, wherein:
in the open configuration, the door is aligned with the axis of the tube to allow fluid to flow into the tube through the inlet from below, and
in the closed configuration, the door is positioned transverse to the axis of the tube to block fluid flow from the tube out through the inlet thereby retaining fluid within the tube as the sampler is raised up.

Unlike the previous embodiment, in this case, the sampler comprises only a closeable valve at the inlet. That is, when the sample is obtained at the bottom of the well, the sample is retained by the inlet valve being close. The outlet at the top remains open. However, water can not enter the sampler, as the sampler is being raised because the water flow is deflected around the sampler due to the tube already being full of water.

The door in this case comprises a single flap 311. The flap in this case is formed from a substantially elliptical sheet of material which is curved about one axis (see FIG. 3e). This means that from end on, the sheet of material forms a circle (see FIG. 3b) but from side on, the sheet of material forms an arc.

The hinge 314 is configured to lie next to the surface of the tube and is configured such that the door is configured to pivot about an axis which lies adjacent to and parallel to an inside surface of the tube.

### Split-Leaf Sampler Valve

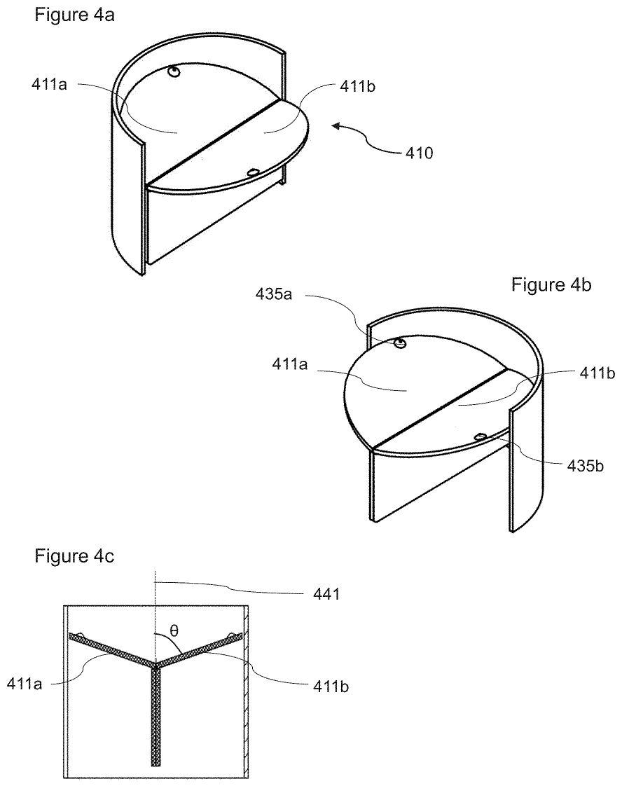

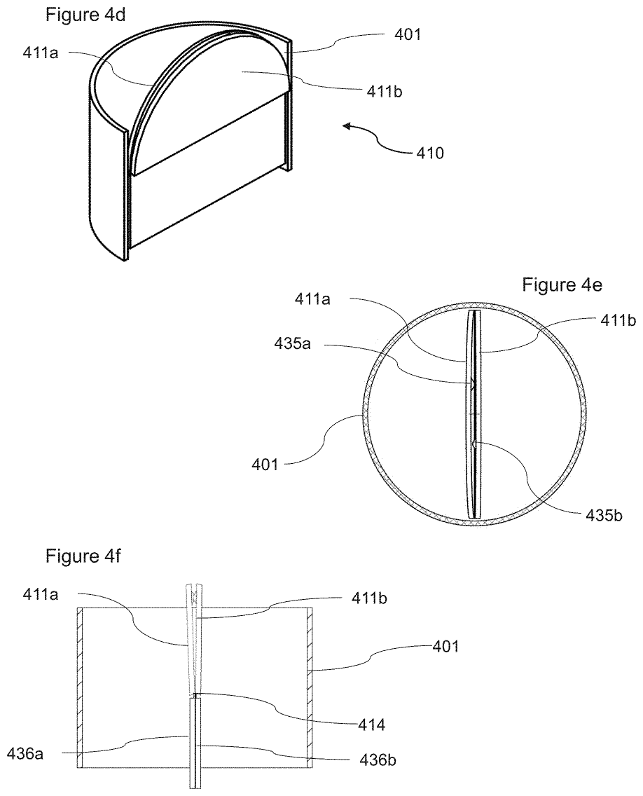

FIGS. 4a-f show an alternative valve type which may be used in conjunction with the above-described sampler. FIGS. 4a-c show a valve in the closed configuration, and FIGS. 4d-f show the valve in the open configuration. In this case, an inlet valve 410 is shown. It will be appreciated that this valve may also be used as an outlet valve.

The valve 410, in this case, has a door comprising two flaps 411a,b configured autonomously to move between open and closed configurations in response to fluid flow through the inlet, wherein:

in the open configuration, the flaps 411a,b are aligned with the axis of the tube to allow fluid to flow into the tube through the valve from below, and
in the closed configuration, the flaps 411a,b is positioned transverse to the axis of the tube to block fluid flow from the tube out through the valve thereby retaining fluid within the tube as the sampler is raised up.

FIGS. 4a and 4b are perspective cut-away views of a valve in a closed position. In these figures, the tube is shown cut-away to more clearly show the position of the flaps within the tube. FIG. 4c is a transverse cross-section of the valve of FIG. 4a in a closed position

FIG. 4d is a further perspective cut-away view of the valve of FIG. 4a valve in an open position. FIG. 4e is a top view of the valve of FIG. 4a valve in an open position. FIG. 4f is cut-away side view of the valve of FIG. 4a in an open position. In this case, it is the tube which is cut away to more clearly show the position of the flaps within the tube.

As shown in the figures, the valve 410 in this case is located directly within the tube 401. Like the embodiment of FIG. 2a, in this case, the door of each of the inlet and outlet valves comprises two flaps 411a, 411b hinged 414 at the middle. That is, in this case, the door comprises a plurality of flaps, each flap 411a, 411b hinged along a diameter of the tube 401. To move from the open to closed position, each door flap 411a, 411b is configured to rotate about a hinge axis which is configured to be transverse to the elongate tube axis 441.

The hinge in this case is formed by taking two sheets of material from which the flaps are formed and connecting the sheets back to back (or surface to surface) along a portion of the sheets (e.g. by gluing, thermo welding or injection molding). The connected portions 436a, 436b are arranged downwardly and vertically along the tube axis with the unconnected portions arranged upwardly to form the flaps 411a, 411b. In this case, the connected portions 436a, 436b are rectangular in shape. Each sheet is configured to allow the flaps to rotate with respect to the connected portions 436a, 436b to allow the valve to open and close. In this case, the region between the connected portion and the unconnected flap portion in each sheet is thinned to allow the sheet to preferentially deform along the hinge axis.

In this case, for a cylindrical tube with a circular cross-section, the shape of each flap 411a, 411b is half of an ellipse, cut through the minor axis. This means that when the flap moves to the closed position, the edge of the flap impinges on the tube around the circumference of the flap thereby sealing the valve. In this case, in the closed position, the angle, θ, that the flaps make with the tube axis is less than 90°. θ in the closed position may be between 40 and 80° (e.g. 70°). A larger angle may allow a greater force to be applied to the sealing surfaces by the weight of the water or through the retrograde flow, and to allow a greater volume of liquid to be stored in the sampler. Because θ in the open position is less than 90°, this embodiment does not need additional stops or lips to prevent the flaps passing beyond 90° (i.e. into a downwardly pointing configuration) and allowing liquid to escape through the valve. Therefore, the valve may be more robust. In addition, because there is reduced need for a lip to seal the valve (the seal is between the flaps and the side of the tube), the cross-sectional area of the sampler in the open configuration can be reduced. For these valves, the ratio between the effective cross-sectional area of the sampler in the open position compared to the closed position may be less than 20%.

In this case, the flaps comprise protrusions 435a,b on their upper surfaces. These protrusions 435a,b are configured to prevent the flaps from reaching an exactly vertical configuration. That is, in the open configuration, the angle, θ, that the flaps 411a, 411b make with the tube axis 441 is greater than 0. θ in the open position may be between 1 and 10°. A larger angle makes the valve more responsive to being closed in response to retrograde flow through the tube. A smaller angle means that the valve offers less resistance to normal flow up through the sampler. In this case, each flap has a protrusion 435a,b which are offset from one another such that they do not impinge when the valve is in the open position. It will be appreciated that other embodiments may have less than one or more than two protrusions. The one or more protrusions may be located on only one of the flaps or distributed across different flaps.

### Sealing Lip Options

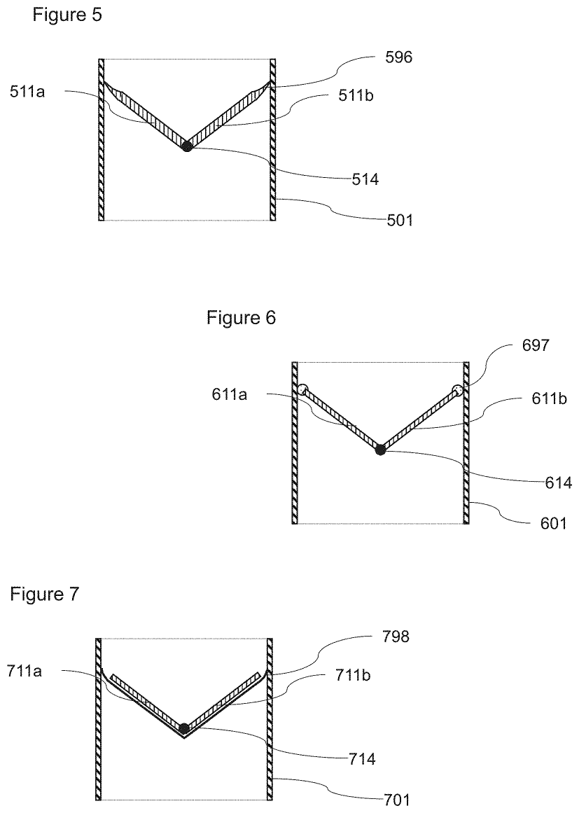

FIGS. 5-7 show an adaptations to the valve which may be used in conjunction with the above-described sampler.

In each case, the valve has a door comprising two flaps 511a,b; 611a,b; 711a,b configured autonomously to move between open and closed configurations (about a hinge or pivot 514; 614; 714) in response to fluid flow through the inlet, wherein:

in the open configuration, the flaps 511a,b; 611a,b; 711a,b are aligned with the axis of the tube 501; 601; 701 to allow fluid to flow into the tube through the valve from below, and
in the closed configuration, the flaps 511a,b; 611a,b; 711a,b is positioned transverse to the axis of the tube to block fluid flow from the tube out through the valve thereby retaining fluid within the tube as the sampler is raised up.

To seal the flaps against the tube, the flaps may comprise a deformable lip (e.g. elastic or resilient) around the perimeter of each flap. This deformable lip may be provided in a variety of ways.

In some embodiments, the material of the flap may be thinned at the outer perimeter to form a thinned deformable lip 596 as shown in FIG. 5. It will be appreciated that, by virtue of the differences in thickness, the inner portion of the flap is more rigid than the edge of the flap. This way of forming a lip allows each flap to be of unitary construction which may reduce manufacturing costs. It also mitigates the need for a means to connect the lip to the flap.

In other embodiments, the flap may be provided with a lip 597 of elastomeric material applied around the edge of the flap as shown in FIG. 6. The elastomeric material may be an adhesive which allows the elastomeric lip to be added directly to the flap without the need for an additional adhesive layer.

In other embodiments, the flap may be provided with a layer of deformable material that extends across the flap surface and slightly beyond to provide a lip 598 on the flap perimeter as shown in FIG. 7. The layer may be attached to the underside of the flaps so that the weight of the water column would squeeze the deformable material between the valve and the tube interior. Other embodiments may have the layer attached to the upper surface of the flaps. Not placing the layer between multiple layers may help reduce weight and thereby allow the flap to move between configurations more easily.

Although the present invention has been described and illustrated with respect to preferred embodiments and preferred uses thereof, it is not to be so limited since modifications and changes can be made therein which are within the full, intended scope of the invention as understood by those skilled in the art.

1. A liquid sampler comprising:
a tube for containing the sample having an inlet at the bottom and an outlet at the top, wherein the outlet is configured to allow fluid to exit the tube;
an inlet check valve at the inlet having a door configured autonomously to move between open and closed configurations in response to fluid flow through the inlet, wherein:
in the open configuration, the door is aligned with the axis of the tube to allow fluid to flow into the tube through the inlet from below, and
in the closed configuration, the door is positioned transverse to the axis of the tube to block fluid flow from the tube out through the inlet thereby retaining fluid within the tube as the sampler is raised up.

2. The liquid sampler according to claim 1, wherein the door comprises a plurality of flaps, each flap being hinged along a diameter of the tube.

3. The liquid sampler according to claim 1 wherein in the closed position, the angle that the flaps make with the tube axis is less than 90°.

4. The liquid sampler according to claim 1 wherein in the open position, the angle that the flaps make with the tube axis is greater than 0°.

5. The liquid sampler according to claim 1, wherein the door is pivotally attached adjacent to the inlet of the tube.

6. The liquid sampler according to claim 1, wherein the door is pivotally attached to an inside surface of the tube, and wherein the door is configured to lie along the inside surface of the tube when in the open configuration.

7. The liquid sampler according to claim 1, wherein the tube has a circular cross-section.

8. The liquid sampler according to claim 1, wherein the door is configured, in the closed configuration, to be substantially the same width as the inner dimension of the tube.

9. The liquid sampler according to claim 1, wherein the inlet valve comprises a lock, the lock configured to lock the door in the closed configuration in response to fluid flow from the tube passing out through the inlet.

10. The liquid sampler according to claim 1, wherein the sampler comprises an outlet check valve at the outlet having a door configured to move between open and closed configurations.

11. The liquid sampler according to claim 1, wherein the sampler comprises an outlet check valve at the outlet which is interchangeable with the inlet check valve.

12. The liquid sampler according to any claim 1, wherein the tube and a said valve are configured to be connectable via a bayonet connection.

13. The liquid sampler according to claim 1, wherein the sampler comprises a tube portion below the inlet valve.

14. The liquid sampler according to claim 1, wherein the tube comprises a drain hole for extraction of the sampler contents, the drain hole being configured to be plugged by a deformable plug.

15. The liquid sampler according to claim 1, wherein the sampler comprises a line for lowering and raising the sampler.

16. The liquid sampler according to claim 1 wherein the door or part of the door is flexible.

17. The liquid sampler according to claim 1 wherein the tube comprises a drain hole configured to be closed by a resilient plug.

18. The liquid sampler according to claim 1 wherein the ratio between the effective cross-sectional area of the sampler in the open position compared to the closed position is less than 60%.

19. A method of sampling fluid in a well using a liquid sampler comprising:
a tube for containing the sample having an inlet at the bottom and an outlet at the top, wherein the outlet is configured to allow fluid to exit the tube;
an inlet check valve at the inlet having a door configured autonomously to move between open and closed configurations in response to fluid flow through the inlet,
wherein the method comprises:
lowering the sampler into the fluid, wherein the as the liquid sampler enters and travels down through the fluid, the fluid flow causes the door to move to an open configuration in which the door is aligned with the axis of the tube to allow fluid to flow into the tube through the inlet from below to capture a sample, and
after the sample has been captured, raising the sampler up through fluid wherein when the sampler is raised, the door is configured to move to a closed configuration in which the door is positioned transverse to the axis of the tube to block fluid flow from the tube out through the inlet thereby retaining fluid within the tube as the sampler is raised up.

20. A liquid sampler comprising:
a tube for containing the sample having an inlet at the bottom, an outlet at the top, and a drain hole configured to be closed by a resilient plug;
an inlet check valve at the inlet having a door configured to move between open and closed configurations, wherein:
in the open configuration, the door is configured to allow fluid to flow into the tube through the inlet from below, and
in the closed configuration, the door is configured to retain fluid within the tube as the sampler is raised up.
